(19) United States
(12) Patent Application Publication
(10) Pub. No.: US 2006/0152646 A1
(43) Pub. Date: Jul. 13, 2006

(54) Switchable lens display

(76) Inventor: Martin Schrader, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 10/524,985

(22) PCT Filed: Aug. 21, 2002
(86) PCT No.: PCT/FI02/00686

§ 371 Date: Oct. 12, 2005

(51) Int. Cl. G02F 1/1335

(52) U.S. Cl. 349/57

(57) ABSTRACT

The display device (10,20,30) according to the invention comprises at least a layer of substantially transparent substrate (S), a pinhole mask (M) carrying an array of pinholes (H) and arranged in front of said substrate (S) each pinhole (H) corresponding to a single pixel, and an array of electrically controllable refractive or diffractive lenses (L) or corresponding optical components arranged between said substrate (S) and said pinhole mask (M) to affect in an electrically controlled manner the divergence of the light travelling through said substrate (S) towards said pinhole mask (M). The invention may be used to create transmissive, reflective or fluorescent displays with high contrast and high brightness.

The present invention relates to a display device according to the preamble of the appended claim 1.

Display technology is one of the key elements when developing new electronic devices, which today in many cases are designed to be portable and typically also feature wireless connectivity for voice and data. In the future displays need to be increasingly capable of reproducing high quality still and live images both in black-and-white and colour formats.

With the goal of bringing display quality closer to that of a paper print, especially the brightness and contrast together with the colour saturation of the displays must be further improved. In order to allow viewing of live video images, the speed of the displays must also be developed without sacrificing the power consumption. To make mass production of the display devices possible, the manufacturing technology should be simple enough in order to allow low prices. To be suitable for small compact devices, the displays should be compact in size and weight.

In the other hand, preferably the display technology should also be capable for constructing larger area displays, which may be used for example as outdoor display panels in sport venues or indoor display panels in exhibition halls or alike.

Prior art solutions for displays suitable to be used in small size portable devices or as larger size display panels include, for example, cathode ray tubes (CRT), liquid crystal displays (LCD), field emission displays (FED), plasma display panels (PDP) and micromirror or other microelectromechanical system-based (MEMS) projection displays.

Traditional CRTs are mainly used in non-portable devices, where the power consumption and rather bulky construction of the displays are not limiting factors. CRTs are not suitable for constructing very large area displays otherwise than by combining several individual CRT units together.

Panel displays based on LCD technology are predominantly used in many applications requiring low power consumption and compact size. LCDs are based on the use of certain organic molecules, liquid crystals, that can be reoriented by an electric field and thus the transmission of light through a layer containing the liquid crystal material can be altered. The major shortcomings of the LCDs are related to their limited brightness, colour reproduction and speed.

FEDs have many similarities with conventional CRTs. In FEDs electrons are accelerated in vacuum towards phosphors which become excited and emit glow. Different phosphor materials are used to create primary red, green, and blue (RGB) colours, respectively. The main difference compared to the CRTs is that the electrons are generated by field emission rather than by thermal emission, so FED consumes less power than a CRT and does not require any substantial warming up time before it can be viewed. Instead of one single electron gun, each pixel comprises several thousands of sub-micrometer tips from which electrons are emitted. The major shortcoming of the FEDs is related to problems achieving operating voltages low enough which would allow FEDs to be used in portable devices. Due to the complicated manufacturing process, FEDs are also expensive display devices and therefore their use is limited to certain niche applications.

A plasma display panel (PDP) can be characterized as being essentially a matrix of tiny fluorescent tubes which are controlled in a sophisticated fashion. In a pixel in PDP a plasma discharge is first induced by an electric field. The discharge creates a plasma containing ions and electrons which gain kinetic energy from the presence of the electric field. These particles collide at high speed with neon and xenon atoms, which thereby are brought to higher excited states and upon de-excitation to lower states emit ultraviolet radiation. This radiation, in turn, excites phosphor material, which emits glow. Different phosphor materials are used to create red, green, and blue (RGB) colours, respectively. The major shortcomings of the PDPs are related to high power consumption and limited possibilities to manufacture display devices thin enough and with pixels small enough to be used in small-size portable devices. Despite of somewhat less stringent requirements on manufacturing technology than for example in the case of FEDs, the price of PDPs is at the moment relatively high.

MEMS-based projection displays make use of electrostatically driven miniature structures, for example micromirrors, to affect the path of the light. Silicon-surface micromachining is a recent and rapidly developing technology for fabricating optical MEMS devices, but it is still a rather demanding manufacturing technology and thus MEMS devices are rather costly.

The main purpose of the present invention is to produce a novel type display device, which provides clear benefits over the prior display devices discussed above. The main advantages of the display device according to the invention are high light efficiency and high contrast. These very desirable properties can be achieved with a simple construction, which makes it possible to use manufacturing technology simple enough in order to allow low prices. The invention can be used in large area display devices, but it is also suitable for small size displays intended, for example, for portable appliances such as mobile phones where the displays should be compact both in size and weight.

To attain the aforementioned properties and purposes, the display device according to the invention is primarily characterized in what will be presented in the characterizing part of the independent claim 1.

The basic gist of the invention is the following. A transparent substrate is arranged to carry an array of electrically switchable and individually addressable lenses. When said lenses are switched on, they focus the light incident from the backside through the transparent substrate into the pinholes of a pinhole mask arranged in front of the substrate. Thus most of the incident light will be concentrated into the pinholes and go through the pinhole mask. When the lenses are switched off, the light will pass the substrate and the switchable lenses substantially undisturbed, i.e. without change in divergence and fall unto the pinhole mask. In this case most of the light will be blocked and only a small fraction of light passes through the pinhole mask. Looking towards the pinhole mask from the side where the light exits said mask, the observer will see bright or dark pixel areas according to the switching state of the individual lenses.

Very high light efficiency can be achieved with the invention, because if so desired, no light conversion or polarization filtering is required for switching a pixel between on and off states.

By adjusting the focus spot size of the light hitting a pinhole by electrically adjusting the corresponding lens to produce different focal lengths (divergences), the brightness of the pixel can be varied between dark (pixel off) and bright (pixel fully on) states. Another possibility to affect the brightness of a pixel is to adjust the on-off duty cycle of the corresponding lens.

The preferred embodiments of the invention and their benefits will become more apparent to a person skilled in the art through the description and examples given hereinbelow, and also through the appended claims.

In the following, the invention will be described in more detail with reference to the appended drawings, in which

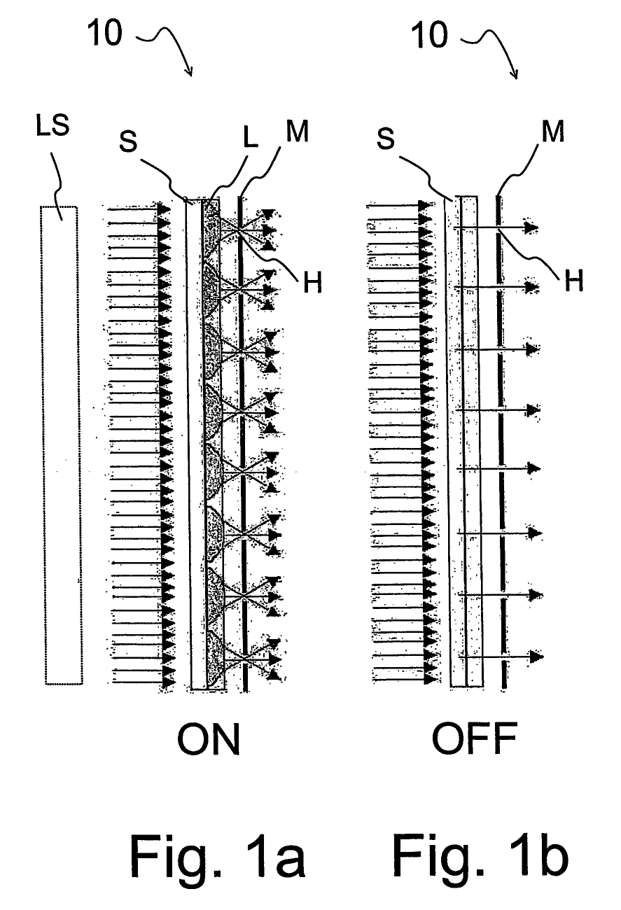

FIGS. 1a,1b illustrate schematically a first embodiment of the invention in on and off states,

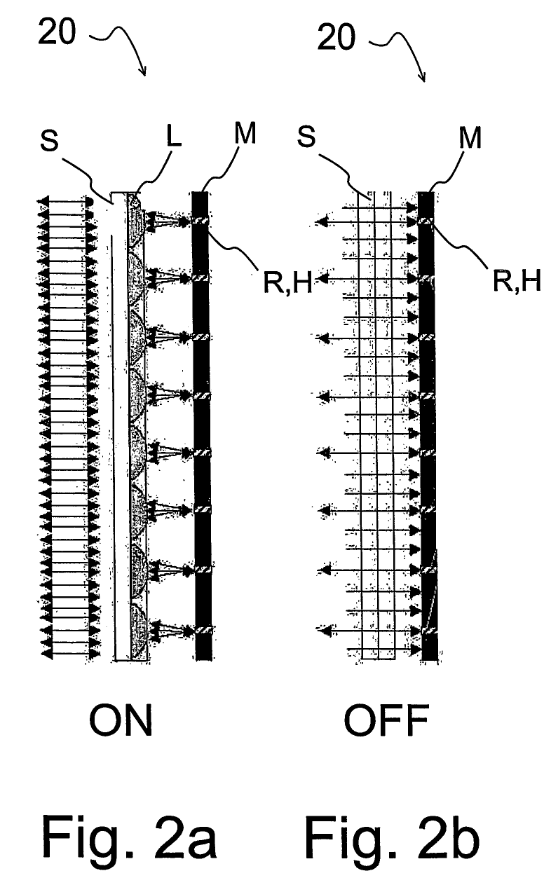

FIGS. 2a, 2b illustrate schematically a second embodiment of the invention in on and off states, and

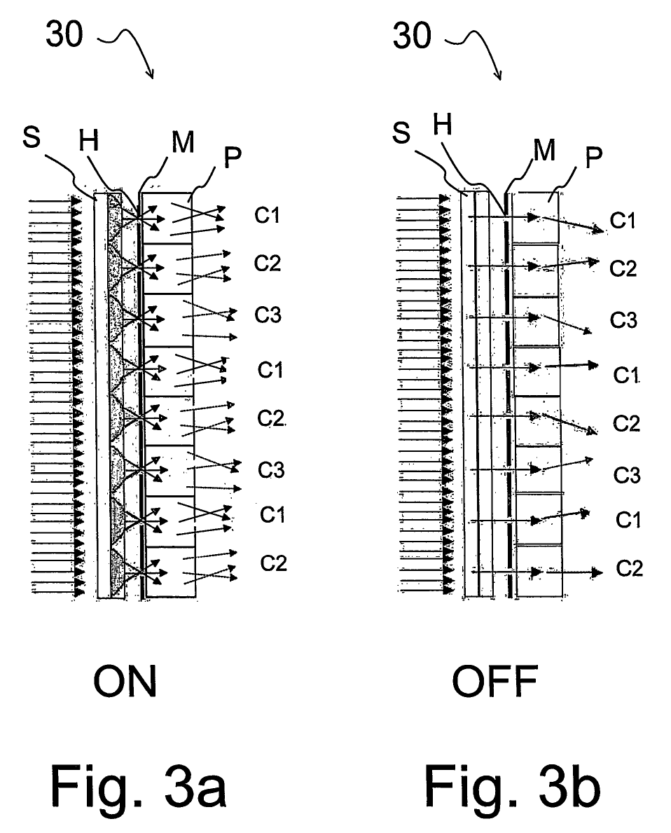

FIGS. 3a, 3b illustrate schematically a third embodiment of the invention in on and off states.

It is to be understood that the drawings presented hereinbelow are designed solely for purposes of illustration and thus not, for example, for showing the various structures and components of the device in their correct relative scales and/or shapes. For the sake of clarity, the components and details which are not essential in order to explain the spirit of the invention have been omitted from the drawings.

FIGS. 1a and 1b illustrate schematically a transmissive display 10 according to the invention.

A transparent substrate S carries an array of electrically switchable lenses L, which lenses can be each individually addressed in order to electrically alter their refractive or diffractive optical power to change the divergence of the light travelling through the lenses L. In order to create visible image, the transmissive display 10 requires a suitable light source LS, i.e. a backlight, located behind the substrate S. Said backlight may be any suitable light source (natural or artificial) providing substantially even illumination of the substrate S with preferably collimated or near collimated light.

When the lenses L are switched on (FIG. 1a), they focus the light incident from the backside through the substrate S into the pinholes H of a pinhole mask M. Thus, most of the incident light will go through the pinhole mask M and when observed from the right side in the figure the pinholes H can be observed as bright pixels.

When the lenses L are switched off (FIG. 1b), the light will pass the substrate S together with the switchable lenses L substantially undisturbed, i.e. without significant change in divergence and fall unto the pinhole mask M. In this case most of the light will be blocked and only a small fraction of light passes through the pinhole mask M. Hence, the pinholes H can be observed as dark pixels.

Looking towards the pinhole mask M from the side where the light exits said mask, the observer will see bright or dark pixel areas according to the switching state of the individual lenses L.

The purpose of a single lens L is to provide electrically controllable means of concentrating/focusing light into an area significantly smaller than the aperture of the lens L itself. Thus, many types of electrically switchable lenses L may be used for this purpose.

The lenses L may be based on, for example, switchable holograms such as those commercially available from DigiLens Inc., California USA. One possibility is to use switchable fresnel zone lenses described in the Applicant's earlier finnish patent application F120000917 and based on the use of electrically deformable viscoelastic gel (polymer). Any other electrically controllable variable focus lens or corresponding switchable optical device known as such and based on either refraction or diffraction may be utilized without deviation from the scope of the current invention.

In principal, the invention is suitable for constructing displays with widely varying display areas, either small displays for compact portable devices or larger displays for TV-sets or public display panels. The aperture (cross-sectional diameter) of the switchable lenses L may vary according to the application. In case of very small diameter lenses L there might be a lower limit where the numerical aperture (NA) of the lens becomes too small and the light concentration factor, i.e. difference between on and off states, is too small to provide a adequate contrast.

The performance of the display, especially the contrast depends mainly on the numerical aperture (NA) of the lenses L in use: The higher the NA the better the light can be concentrated at the focus. A tighter focus means a smaller pinhole can be used without sacrificing light in the on-state. The smaller pinhole reduces the background in the off-state. Thus, a higher numerical aperture leads to a better contrast.

The following example gives an idea of the potential performance of the display device according to the invention.

Consider diffractive microlenses L with diameter d=1 mm and focal length f=5 mm leading to a numerical aperture N.A.=0.1. A lens L with diffraction efficiency of 60% will focus 60% of the incoming light into a diffraction limited focal spot.

The theoretical contrast of a transmission display 10 transmitting only the light that passes a pinhole H of the size of the diffraction limited spot is calculated as follows.

The cross-sectional lens area A is given by Eq.(1):

$$A = 2 {π ( \frac{d}{2} )}^{2} = 0.785 {mm}^{2} \qquad ( 1 )$$

The area of a diffraction limited focus, when wavelength λ=500 nm is given by Eq. (2):

$$a = 2 {π ( \frac{0.61 λ}{NA} )}^{2} = 2 {π ( \frac{0.61 * 0.5}{0.1} )}^{2} = 58 μ {m}^{2} \qquad ( 2 )$$

Therefore the ratio of the aforementioned focus area and the lens area is:

$$\frac{a}{A} = \frac{58}{785000} \approx \frac{1}{13500} \qquad ( 3 )$$

If assuming a very reasonable 60% diffraction efficiency for the lens L, then the contrast between off (dark) and on (bright) states of a pixel will be better than 1:8000.

The rough calculation given above assumes coherent and collimated illumination and does not consider any stray light or cross-talk between adjacent pixels. Nevertheless it shows, that very high contrast can be easily achieved with the invention.

The response time of the display depends on the switching speed of the electrically controllable lenses L and their driving schemes. In general, if the display according to the invention is designed to utilize LCD based switchable lenses, this naturally leads to switching speed close to the normal LCD performance. Switchable polymer lenses described by the Applicant for example in the aforementioned earlier application FI20000917 promise faster operation speed.

An important benefit of the current invention is that the display device can be designed to work without polarized light. This, of course, depends on the type of the switchable lenses L in use. The fact that polarized light is not required makes it possible to achieve high light efficiency and high brightness.

Within the spirit and scope of the present invention also other types of displays than transmissive displays 10 may be constructed. The invention may used, for example, to construct reflective or fluorescence based displays.

FIGS. 2a and 2b describe schematically a reflective display 20 according to the invention. The surface of pinhole mask M towards lenses L is arranged to be at least partly light absorbing. The pinholes H are equipped with reflective mirrors R. When light through the lenses L hits the pinhole mask M and the pinholes/mirrors R so that light is focused onto the mirrors R (FIG. 2a), most of the light reflects back through the lenses L towards an observer situated now on left side of the device. When the lenses L are not activated (FIG. 2b), most of the light becomes absorbed by the pinhole mask M. A reflective display 20 may be operated in the ambient natural or artificial light without necessarily requiring any light source arranged in the display device itself.

FIGS. 3a and 3b describe schematically still another possible embodiment of the invention. In a fluorescence based display 30 the illumination transmitted through the pinholes H in a pinhole mask M is used to excite phosphor material P. Different phosphor materials P may be used to create different colours, for example RGB-type primary colours. In FIGS. 3a and 3b the phosphor materials P might be arranged for example so that C1=R (red), C2=G (green) and C3=B (blue).

It is to be understood that the term pinhole is used here and in the claims in a broad sense and therefore referring to any aperture or corresponding structure suitable for defining a spatially limited path for the light through the pinhole mask (M).

In case that the excitation of the phosphor materials P is non-linear, i.e. requires for example the so-called two-photon excitation, the pinholes H might not be required at all since fluorescence is generated only in the focus of the beams, where the light intensity is high enough to create fluorescent excitation.

In general, the pixel geometry of the displays 10,20,30 according to the invention is arbitrary and is limited only by the physical size of the lenses L and the capabilities of the electronic driving circuitry operating said lenses L. The pixel geometry, i.e. how the pixels in a display are arranged respect to each other needs not to be rectangular. Thus, the pixels can be arranged in rings or any other suitable geometry to suit the particular application.

The size and shape of the lenses L can be varied and these parameters are limited only by the operation principle of said lenses. Any electrically controllable lens type known as such in the art may be used. The only common aspect is the concentration of light into an area small compared to the cross-sectional size of the lens L.

The invention is suitable for creating both black-and-white or colour displays. Full colour displays may be constructed, for example, by creating primary colours in a manner described in FIGS. 3a and 3b. Any other colour may be created from the primary colours by mixing the primary colours in a desired ratio.

The brightness of a single pixel may be controlled by adjusting the lens L to create a suitable degree of focusing. In the simplest embodiment the lens L may only have two different states; on and off. A larger range of grey levels (or levels of primary colours) may be achieved by utilizing electrically controllable lenses L, where the effective focal length of the lenses may be controlled stepwise or in a continuous manner.

A preferred method to adjust the brightness of a pixel is to adjust the on-off duty cycle of the switchable lenses L. When the voltage or corresponding electric control of a lens L in a pixel is activated/deactivated at frequencies which are sufficiently high, for example at >25 Hz, the human visual perception is not able to distinguish the flickering between the maximum brightness (pixel on) and black (pixel off), but instead observes an pixel with a certain intermediate brightness.

Even though the invention has been shown and described above with respect to selected types of embodiments, it should be understood that these embodiments are only examples and that a person skilled in the art could construct other display devices utilizing techniques other than those specifically disclosed herein while still remaining within the spirit and scope of the present invention. It should, therefore, be understood that various omissions and substitutions and changes in the form and detail of the display devices illustrated, as well as in the operation of the same, may be made by those skilled in the art without departing from the spirit of the invention.

For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to restrict the invention only in the manner indicated by the scope of the claims appended hereto.

1. A display device comprising an array of pixels (P), characterized in that said display device (10,20,30) comprises at least
a layer of substantially transparent substrate (S),
a pinhole mask (M) carrying an array of pinholes (H) or corresponding limiting apertures and arranged in front of said substrate (S), each pinhole (H) corresponding to a single pixel, and
an array of electrically controllable refractive or diffractive lenses (L) or corresponding optical components arranged between said substrate (S) and said pinhole mask (M) to affect in an electrically controlled manner the divergence of the light travelling through said substrate (S) and said lenses (L) towards said pinhole mask (M).

2. The display device according to claim 1, characterized in that the pinholes (H) in the pinhole mask (M) are arranged to be light transmissive in order to compose a transmissive display device (10).

3. The display device according to claim 1, characterized in that the pinholes (H) in the pinhole mask (M) are arranged to be at least partly light reflective and the pinhole mask (M) is arranged to be at least partly light absorbing in order to compose a reflective display device (20).

4. The display device according to claim 1, characterized in that the pinholes (H) in the pinhole mask (M) are arranged to determine an optical path towards phosphor material (P) in order to compose a fluorescent display device (30)

5. The display device according to claim 4, characterized in that said display device (30) comprises several different type of phosphor materials (P) in order to compose a colour display.

6. The display device according to claim 4, characterized in that the electrically controllable lenses (L) are based on the use of electrically deformable viscoelastic gel.

7. The display device according to claim 4, characterized in that the electrically controllable lenses (L) are liquid crystal based switchable lenses.

8. The display device according to claim 4, characterized in that the electrically controllable lenses (L) are variable focus lenses with each having two or more separate electrically selectable focus values.

9. The display device according to claim 4, characterized in that the electrically controllable lenses (L) are arranged to be controlled through affecting their on-off duty cycle.

10. The display device according to claim 4, characterized in that the display device (10,20,30) is a panel display for a wireless mobile station or mobile phone.

11. The display device according to claim 3, characterized in that the electrically controllable lenses (L) are based on the use of electrically deformable viscoelastic gel.

12. The display device according to claim 3, characterized in that the electrically controllable lenses (L) are liquid crystal based switchable lenses.

13. The display device according to claim 3, characterized in that the electrically controllable lenses (L) are variable focus lenses with each having two or more separate electrically selectable focus values.

14. The display device according to claim 3, characterized in that the electrically controllable lenses (L) are arranged to be controlled through affecting their on-off duty cycle.

15. The display device according to claim 3, characterized in that the display device (10,20,30) is a panel display for a wireless mobile station or mobile phone.

16. The display device according to claim 2, characterized in that the electrically controllable lenses (L) are based on the use of electrically deformable viscoelastic gel.

17. The display device according to claim 2, characterized in that the electrically controllable lenses (L) are liquid crystal based switchable lenses.

18. The display device according to claim 2, characterized in that the electrically controllable lenses (L) are variable focus lenses with each having two or more separate electrically selectable focus values.

19. The display device according to claim 2, characterized in that the electrically controllable lenses (L) are arranged to be controlled through affecting their on-off duty cycle.

20. The display device according to claim 2, characterized in that the display device (10,20,30) is a panel display for a wireless mobile station or mobile phone.

21. The display device according to claim 1, characterized in that the electrically controllable lenses (L) are based on the use of electrically deformable viscoelastic gel.

22. The display device according to claim 1, characterized in that the electrically controllable lenses (L) are liquid crystal based switchable lenses.

23. The display device according to claim 1, characterized in that the electrically controllable lenses (L) are variable focus lenses with each having two or more separate electrically selectable focus values.

24. The display device according to claim 1, characterized in that the electrically controllable lenses (L) are arranged to be controlled through affecting their on-off duty cycle.

25. The display device according to claim 1, characterized in that the display device (10,20,30) is a panel display for a wireless mobile station or mobile phone.
